(19) United States
(12) Patent Application Publication
(10) Pub. No.: US 2026/0187952 A1
(43) Pub. Date: Jul. 2, 2026

(54) METHOD FOR EDITING 3 DIMENSION IMAGE BASED ON POINT DRAG

(71) Applicant: ELECTRONICS AND TELECOMMUNICATIONS RESEARCH INSTITUTE, Daejeon (KR)

(72) Inventors: Jiwan KIM, Daejeon (KR); Do Hyung KIM, Daejeon (KR)

(73) Assignee: ELECTRONICS AND TELECOMMUNICATIONS RESEARCH INSTITUTE, Daejeon (KR)

(21) Appl. No.: 19/305,371

(22) Filed: Aug. 20, 2025

(30) Foreign Application Priority Data
Dec. 30, 2024 (KR) 10-2024-0200435

(51) Int. Cl. G06T 19/20; G06F 3/04845

(52) U.S. Cl. CPC G06T 19/20; G06F 3/04845; G06T 2200/24

(57) ABSTRACT

An image editing method, comprising: obtaining, by an image editing device, an original target image, an original source image, and editing information; editing, by the image editing device, the original target image based on the editing information; generating, by the image editing device, a depth map of the edited target image; estimating, by the image editing device, a depth map of the original source image from the depth map of the edited target image using a transformation equation; modifying, image device, by the editing the transformation equation by comparing the estimated depth map of the source image with a depth map of the original source image; and generating, by the image editing device, an edited source image from the edited target image using the modified transformation equation.

### CROSS REFERENCE TO RELATED APPLICATION

The present application claims priority to Korean Patent Application No. 10-2024-0200435, filed Dec. 30, 2024, the entire contents of which are incorporated herein for all purposes by this reference.

### BACKGROUND OF THE INVENTION

### Field of the Invention

The technology described below relates to an image editing method.

### Description of the Related Art

Diffusion model-based image editing is one type of image editing technology in which a user inputs information that includes the intended modification. Attempts have been made to apply such image editing techniques to the editing of three-dimensional (3D) images. However, conventional 3D image editing techniques utilizing diffusion models have primarily modified only the style of the target. As a result, the geometric information of the original image is not significantly changed, which makes it difficult to perform true 3D editing.

### DOCUMENTS OF RELATED ART

### Patent Documents

United States Patent Application Publication US 2024/0378797 A1

### SUMMARY OF THE INVENTION

Unlike general text-based editing methods, point-based editing methods cause significant changes in the three-dimensional (3D) geometric information of the edited region. Accordingly, to extend such editing to multiview images, it is necessary to estimate the 3D information of the regions that differ from the original image due to the modification. Conventionally, multiview extension has been achieved by applying linear regression to single-image depth estimation and correcting scale and shift parameters relative to the original image.

The technology described below proposes a method that applies such editing during rendering time of a view synthesis technique, such as Gaussian Splatting. According to this method, when a user edits a specific 2D view using conventional point-based image editing, the edited result can be extended to 3D while preserving the geometric information of the original image.

The technology described below is to disclose an image editing method.

In one embodiment, an image editing method, comprising: obtaining, by an image editing device, an original target image, an original source image, and editing information; editing, by the image editing device, the original target image based on the editing information; generating, by the image editing device, a depth map of the edited target image; estimating, by the image editing device, a depth map of the original source image from the depth map of the edited target image using a transformation equation; modifying, by the image editing device, the transformation equation by comparing the estimated depth map of the source image with a depth map of the original source image; and generating, by the image editing device, an edited source image from the edited target image using the modified transformation equation.

The technology described below enables editing of three-dimensional (3D) images. The technology described below enables editing of 3D images using a point-based editing method. The technology described below allows a 2D editing technique to be extended for editing images in a 3D environment with ease. The technology described below enables generation of natural 3D images information and geometric by maintaining depth consistency in the edited region. The technology described below enhances productivity in the creation of 3D content across various graphics domains, including AR and VR.

### BRIEF DESCRIPTION OF THE DRAWINGS

FIG. 1 illustrates one embodiment in which an image editing device (100) performs an image editing method.

FIG. 2 illustrates one embodiment (200) in which an image editing device performs an image editing method.

FIG. 3 illustrates one embodiment in which an image editing device performs an image editing method.

FIG. 4 illustrates one embodiment in which an image editing device performs an image editing method.

FIG. 5 illustrates one embodiment in which an image is edited by applying the image editing method.

FIG. 6 illustrates a configuration of one embodiment of an image editing device (300).

### DETAILED DESCRIPTION OF THE INVENTION

Since the technology to be described below can have various changes and can have various embodiments, specific embodiments are illustrated in the drawings and described in detail. However, this is not intended to limit the technology described below to specific embodiments, and it should be understood to include all changes, equivalents, and alternatives falling within the spirit and scope of the technology described below.

The terms “first,” “second,” “A,” “B,” etc., may be used to describe various components, but the components are not limited by the terms, which are only used to distinguish one component from another. For example, without departing from the scope of the following description, a first component may be referred to as a second component, and similarly, a second component may also be referred to as a first component. The term “and/or” includes any and all combinations of one or more of the associated listed items.

As used herein, the singular forms should be understood to include the plural forms unless the context clearly indicates otherwise, and the terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components and/or groups thereof.

Before describing the drawings in detail, it should be clarified that the division of constituent parts in this specification is merely a division by main functions of each constituent part. That is, two or more constituent parts to be described below may be combined into one constituent part, or one constituent part may be divided into two or more constituent parts for each subdivided function. In addition, each of the constituent parts described below may additionally perform some or all of the functions of other constituent parts in addition to the main function of the constituent part itself, and it goes without saying that some of the main functions performed by each of the constituent parts may be performed exclusively by other components.

Also, in performing a method or an operation method, processes constituting the method may take place differently from the stated order unless clearly specified in the context. That is, each process may occur in the same order as described, may be performed substantially simultaneously, or may be performed in reverse order.

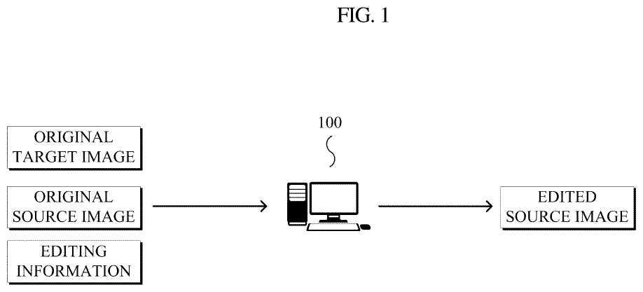

FIG. 1 illustrates one embodiment in which an image editing device (100) performs an image editing method.

The image editing device (100) may be implemented in various physical forms. For example, the image editing device (100) may take the form of a PC, a laptop, a smart device, a server, or a dedicated data processing chipset.

At least one image editing device (100) may be provided. For example, the image editing method may be performed by a single image editing device or may be divided and performed cooperatively by multiple devices.

The image editing device (100) may be a device that performs the image editing method. The image editing device (100) may obtain an original target image, an original source image, and editing information. The image editing device (100) may edit the original target image based on the editing information. The image editing device (100) may generate an edited source image based on the edited target image.

To reflect the edited information from the target image to the source view, relative positional information between the two views and 3D depth information are required. The positional information between images may be obtained during the view synthesis process. However, the 3D information of the edited region does not exist in the original image. Therefore, a depth estimation process is required. To this end, a single-image depth estimation technique is used. The resulting data differs from the geometric information of the original multi-view images, and thus, a scale and shift adjustment process are performed.

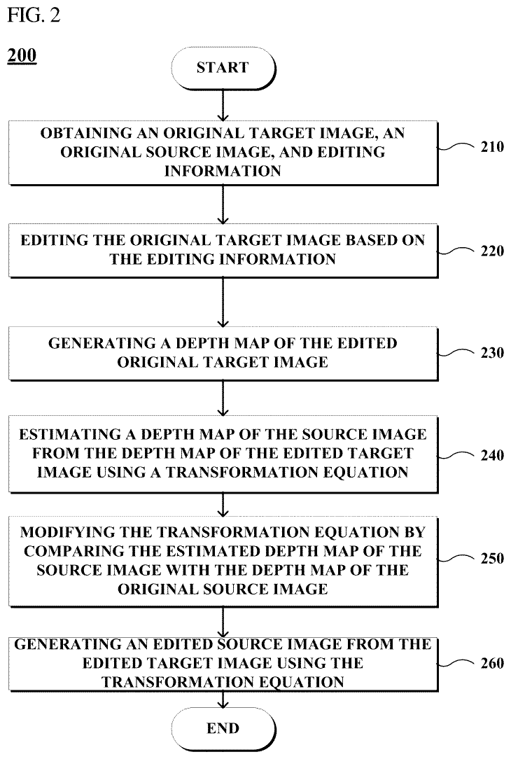

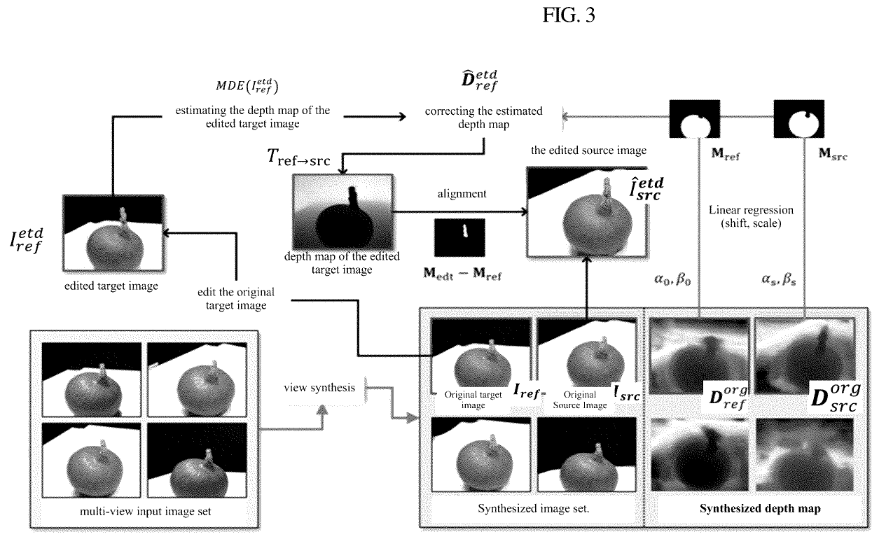

FIGS. 2 and 3 illustrate one embodiment (200) in which an image editing device performs an image editing method.

The image editing device may obtain an original target image, an original source image, and editing information (210).

I_{ref} may be the original target image. I_{src} may be the original target image.

The target image and the source image may be images included in constructed from a multi-view input image set.

The target image and the source image may be images included in a synthesized image set. The synthesized image set may comprise images obtained by applying a view synthesis method to images included in a multi-view input image set.

The target image and the source image may be images captured at different viewpoints. The target image and the source image may be images of a single object, captured from different viewpoints.

The target image may be an image to be edited. The source image may be an image not to be edited.

The result of editing the target image may be reflected in the source image. Therefore, the edited result of the target image may be reflected in the source image, which shows the object from a viewpoint different from that of the target image.

The editing information may include information on how the target image is to be edited. The editing information may include information on the region to be edited. The editing information may include information on geometric changes in the region to be edited. The editing information may relate to a point-drag-based image editing method. The editing information may include information on the region to be edited, the starting point, and the ending point of the drag specified by the user. Specifically, the user may modify a certain region by using a drag operation.

The image editing device may edit the original target image based on the editing information (220).

$${I}_{ref}^{etd}$$

may be the edited target image.

Editing the original target image may be based on a drag-based image editing method. Editing the original target image may involve modifying a part of an object represented in the original target image.

The image editing device may generate a depth map of the edited original target image (230).

Generating the depth map may comprise estimating a depth map of the edited target image and correcting the estimated depth map of the edited target image.

$$MDE ( {I}_{ref}^{etd} )$$

may be the result of estimating the depth map of the edited target image.

$${\hat{D}}_{ref}^{etd}$$

may be the corrected result of the estimated depth of the edited target image.

Estimating the depth map of the edited target image may be performed using a depth estimation model.

The depth estimation model may be a model for estimating a depth map from an image. The depth estimation model may be a trained model based on training data. The depth estimation model may be a model based on machine learning (ML). The depth estimation model may be a model based on an artificial neural network (ANN).

Correcting the estimated depth map of edited target image may comprise making it similar to the depth map of the original target image.

Correcting the estimated depth map of edited target image may comprise adjusting non-edited regions to be similar to those of the original target image. A mask, which indicates non-edited regions of the original target image, may be used for this purpose.

Correcting the estimated depth map of edited target image may comprise applying a first parameter to the estimated depth map of edited target image. The first parameter may be a parameter that transforms the estimated depth map of edited target image to be similar to the depth map of the original target image. The first parameter may be a scale and shift parameter.

Equation 1 and Equation 2 may be used to correct the estimated depth map of edited target image.

$${\hat{D}}_{ref}^{etd} = MDE ( {I}_{ref}^{etd} ) [ \begin{matrix}{α}_{0} \\ {β}_{0}\end{matrix} ] \qquad [ Equation 1 ]$$

$$( {α}_{0} , {β}_{0} ) = {min}_{{α}_{0} , {β}_{0}} {‖ ( {D}_{ref}^{org} - MDE ( {I}_{ref}^{etd} ) [ \begin{matrix}{α}_{0} \\ {β}_{0}\end{matrix} ] ) ⊙ {M}_{ref} ‖}_{2} \qquad [ Equation 2 ]$$

In Equation 1 and Equation 2,

$${D}_{ref}^{org}$$

may be the depth map of the original target image. In Equation 1 and Equation 2, α₀, β₀ may be the first parameter. In Equation 1 and Equation 2, M_{ref} may be a mask indicating non-edited regions of the original target image.

The image editing device may estimate a depth map of the source image from the depth map of the edited target image using a transformation equation (240).

T_{ref→src} may be the transformation equation.

$${\hat{D}}_{src}^{fin}$$

may be the estimated depth map of the source image.

The transformation equation may be an equation that transforms the target image into the source image. The transformation equation may be an equation that transforms the depth map of the target image into the depth map of the source image.

If necessary, the image editing device may correct the estimated depth map of the source image.

Correcting the estimated depth map of the source image may comprise making it similar to the depth map of the original source image. Correcting the estimated depth map may comprise adjusting non-edited regions to be similar to those of the original source image. A mask for non-edited regions of the original source image may be used for this purpose.

Correcting the estimated depth map may comprise applying a second parameter to the depth map.

The second parameter may be a parameter that transforms the estimated depth map to be similar to the depth map of the original source image. The second parameter may be a scale and shift parameter.

Equation 3 and Equation 4 may be used to correct the estimated depth map of the source image.

$${\hat{D}}_{src}^{fin} = {T}_{ref \to src} ( {\hat{D}}_{ref}^{etd} ) [ \begin{matrix}{α}_{s} \\ {β}_{s}\end{matrix} ] \qquad [ Equation 3 ]$$

$$( {α}_{s} , {β}_{s} ) = {min}_{{α}_{s} , {β}_{s}} {‖ ( {D}_{src}^{org} - {T}_{ref \to src} ( {\hat{D}}_{ref}^{etd} ) [ \begin{matrix}{α}_{s} \\ {β}_{s}\end{matrix} ] ) ⊙ {M}_{src} ‖}_{2} \qquad [ Equation 4 ]$$

In Equations 3 and 4, α_{S}, β_{S} may be the second parameter. In Equations 3 and 4, M_{src} may be a mask indicating non-edited regions of the original source image.

The image editing device may modify the transformation equation by comparing the estimated depth map of the source image with the depth map of the original source image (250).

$${D}_{src}^{org}$$

may be the depth map of the original source image.

Modifying the transformation equation may comprise updating the equation so as to minimize the difference between the estimated depth map of the source image and the depth map of the original source image.

The image editing device may generate an edited source image from the edited target image using the transformation equation (260).

$${\hat{I}}_{src}^{etd}$$

may be the edited source image.

As described above, the transformation equation may be an equation that transforms the target image into the source image.

Therefore, the edited source image may be generated by applying the transformation equation to the edited target image.

Generating the edited source image may comprise applying the transformation equation to the edited target image, and extracting only the region corresponding to the edited region from the result, and reflecting it in the original source image. A mask that extracts only the region corresponding to the edited region may be used for this purpose.

Equation 5 may be used to generate the edited source image.

$${\hat{I}}_{src}^{etd} = ( {T}_{ref \to src} ( {\hat{I}}_{src}^{etd} ) ⊙ ( {M}_{edt} - {M}_{ref} ) ) ⋃ {I}_{src} \qquad [ Equation 5 ]$$

In Equation 5, M_{edt}−M_{ref} may be a mask for extracting only the region corresponding to the edited region.

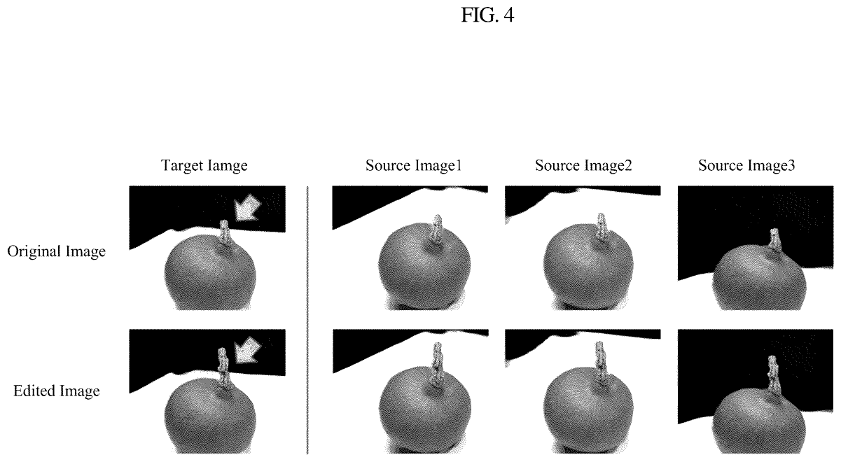

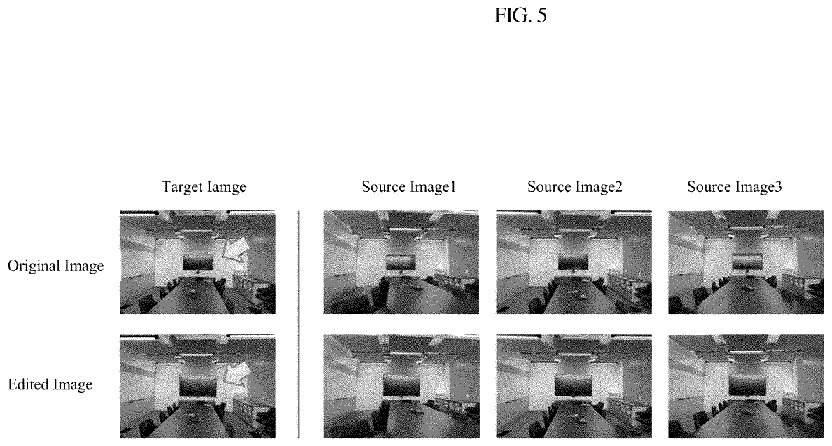

FIGS. 4 and 5 illustrate one embodiment in which the image editing method is applied to edit an image.

In FIGS. 4 and 5, the top-left area shows the target image selected by the user. In FIGS. 4 and 5, the bottom-left area shows the edited target image edited using a point-based image editing technique. In FIGS. 4 and 5, the top-right area shows the source image. In FIGS. 4 and 5, the result shows the source image with the edited information reflected. In FIGS. 4 and 5, the arrow indicates the region modified by the user. As shown in FIGS. 4 and 5, the image editing method allows the editing result from one viewpoint to be reflected in an image from another viewpoint.

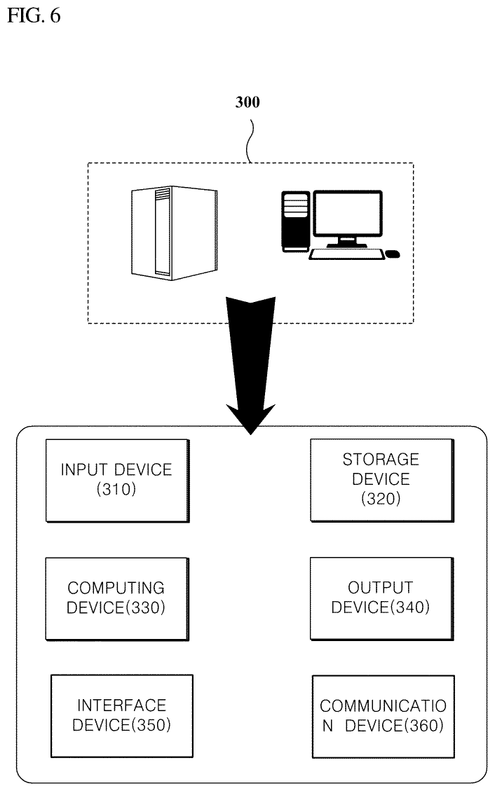

FIG. 6 illustrates a configuration of one embodiment of the image editing device (300).

The image editing device (300) may correspond to the image editing device (100) described above with reference to FIG. 1. That is, the image editing device (300) may be a device that performs the above-described image editing method.

The image editing device (300) may comprise at least one input device (310), storage device (320), computing device (330), output device (340), interface device (350), and communication device (360).

The input device (310) may receive data, information, or models required to perform the above-described image editing method. The input device (310) may receive the original target image, original source image, and editing information. It may also receive a depth estimation model, and training data necessary to train the model. The input device (310) may include devices for inputting commands or data, such as a keyboard, mouse, touchscreen, joystick, trackball, touchpad, scanner, or webcam. It may also include configurations for receiving data through external storage devices such as USB, CD, or hard disk. Additionally, it may receive data through a dedicated measurement device or an external database. Furthermore, the input device (310) may receive data wirelessly or via wired connections through the communication device (360). The input device (310) may also receive control signals for controlling the image editing device (300).

The storage device (320) may store data, information, or models required to perform the image editing method. The storage device (320) may store the original target image, original source image, and editing information. It may also store the depth estimation model and training data for training the model. The storage device (320) may store commands required by the computing device (330) to perform operations of the image editing method. It may also store information generated during processing. In other words, the storage device (320) may include memory. For example, the storage device may include HDD (Hard Disk Drive), SSD (Solid State Drive), ROM, RAM, CD-ROM, magnetic tape, or floppy disk.

The computing device (330) may perform computations required to execute the above-described image editing method. It may perform operations to acquire the original target image, original source image, and editing information; to edit the original target image based on the editing information; to generate a depth map of the edited target image; to estimate a source image depth map from the edited target image depth map using a transformation formula; to modify the transformation formula based on the comparison between the estimated and original source image depth maps; and to generate the edited source image from the edited target image using the transformation formula.

The computing device (330) may be a processor, an application processor (AP), or a chip with embedded software. For example, it may include a CPU (Central Processing Unit), GPU (Graphics Processing Unit), or NPU (Neural Processing Unit). The computing device (330) may generate control signals for the image editing device (300) and control the input device (310), storage device (320), output device (340), interface device (350), and communication device (360).

The output device (340) may output certain data, information, or models. It may output them externally or display interface information, input data, or analysis results. It may include visual, haptic, auditory, gustatory, or olfactory output mechanisms. The output device (340) may take various physical forms such as a display, speaker, vibration motor, or printer. It may output data stored in the storage device (320) or generated by the computing device (330).

The interface device (350) may receive commands and data from external sources. It may receive control signals for the image editing device (300) and output analysis results. It may also receive necessary data through physically connected input devices or external storage.

The communication device (360) may receive information and models needed to perform the image editing method. It may transmit and receive the original target image, original source image, editing information, and depth estimation model. It may receive control signals to control the image editing device (300) and transmit analysis results. The communication device (360) may transmit and receive data, information, and models over a wired or wireless network, and may support communication methods such as Wi-Fi, Wi-Fi Direct, Bluetooth, UWB (Ultra-Wide Band), NFC (Near Field Communication), USB (Universal Serial Bus), HDMI (High Definition Multimedia Interface), or LAN (Local Area Network).

The above-described image editing method may be realized as a program (or application) including a computer-executable algorithm.

The program may be stored and provided in a transitory or non-transitory computer-readable medium.

The transitory computer-readable medium refers to various RAMs such as static RAM (SRAM), dynamic RAM (DRAM), synchronous DRAM (SDRAM), Double Data Rate SDRAM (DDR SDRAM), Enhanced SDRAM (ESDRAM), synchronous DRAM (SLDRAM), and Direct Rambus RAM (DRRAM).

The non-transitory computer-readable medium refers to a medium that stores data semi-permanently and can be read by a device, rather than a medium, such as a register, a cache, and a memory, which stores data for a short period of time. Specifically, the various applications or programs described above may be stored and provided in the non-transitory computer-readable medium, such as a CD, a DVD, a hard disk, a Blu-ray disk, a USB, a memory card, a read-only memory (ROM), a programmable read-only memory (PROM), an erasable PROM (EPROM), an electrically EPROM (EEPROM), or a flash memory.

The embodiments and the accompanying drawings only clearly show part of the technical idea included in the above-described technology, and it is obvious that all modification and specific embodiments that can be easily inferred by those skilled in the art within the scope of the technical idea included in the specification and drawings of the above-mentioned technology are included in the scope of the above-described technology.

What is claimed is:

1. An image editing method, comprising:
obtaining, by an image editing device, an original target image, an original source image, and editing information;
editing, by the image editing device, the original target image based on the editing information;
generating, by the image editing device, a depth map of the edited target image;
estimating, by the image editing device, a depth map of the original source image from the depth map of the edited target image using a transformation equation;
modifying, by the image editing device, the transformation equation by comparing the estimated depth map of the source image with a depth map of the original source image; and
generating, by the image editing device, an edited source image from the edited target image using the modified transformation equation.

2. The image editing method according to claim 1,
wherein the original target image and the original source image are images captured from different viewpoints.

3. The image editing method according to claim 1,
wherein the editing information comprises information related to point-drag-based image editing.

4. The image editing method according to claim 3,
wherein the editing information comprises a user-specified region to be modified, a drag start point, and a drag end point.

5. The image editing method according to claim 1,
wherein generating the depth map comprises estimating a depth map of the edited target image and correcting the estimated depth map of the edited target image.

6. The image editing method according to claim 5,
wherein estimating the depth map of the edited target image comprises using a depth estimation model,
and the depth estimation model is configured to estimate a depth map from an image.

7. The image editing method according to claim 5,
wherein correcting the estimated depth map of the edited target image comprises making non-edited regions of the estimated depth map of the edited target image similar to corresponding regions of a depth map of the original target image.

8. The image editing method according to claim 1,
further comprising, by an image editing device, correcting the estimated depth map of the source image,
wherein correcting the estimated depth map of the source image comprises making the estimated depth map of the source image similar to a depth map of the original source image.

9. The image editing method according to claim 1,
wherein modifying the transformation equation comprises modifying the equation so as to minimize a difference between the estimated depth map of the source image and a depth map of the original source image.

10. The image editing method according to claim 1,
wherein generating the edited source image comprises applying the transformation equation to the edited target image,
and extracting only a region corresponding to the edited region from the transformed result,
and reflecting the extracted region in the original source image.

11. An image editing device, comprising:
a computing device; and a storage device configured to store instructions that, when executed by the computing device, cause the image editing device to:
obtain an original target image, an original source image, and editing information;
edit the original target image based on the editing information;
generate a depth map of the edited target image;
estimate a depth map of the original source image from the depth map of the edited target image using a transformation equation;
modify the transformation equation by comparing the estimated depth map of the source image with a depth map of the original source image; and
generate an edited source image from the edited target image using the modified transformation equation.

12. The image editing device according to claim 11,
wherein the original target image and the original source image are images captured from different viewpoints.

13. The image editing device according to claim 11,
wherein the editing information comprises information related to point-drag-based image editing.

14. The image editing device according to claim 13,
wherein the editing information comprises a user-specified region to be modified, a drag start point, and a drag end point.

15. The image editing device according to claim 11,
wherein generating the depth map comprises estimating a depth map of the edited target image and correcting the estimated depth map of the edited target image.

16. The image editing device according to claim 15,
wherein estimating the depth map of the edited target image comprises using a depth estimation model,
and the depth estimation model is configured to estimate a depth map from an image.

17. The image editing device according to claim 15,
wherein correcting the estimated depth map of the edited target image comprises making non-edited regions of the estimated depth map of the edited target image similar to corresponding regions of a depth map of the original target image.

18. The image editing device according to claim 11,
further comprising, by an image editing device, correcting the estimated depth map of the source image,
wherein correcting the estimated depth map of the source image comprises making the estimated depth map of the source image similar to a depth map of the original source image.

19. The image editing device according to claim 11,
wherein modifying the transformation equation comprises modifying the equation so as to minimize a difference between the estimated depth map of the source image and a depth map of the original source image.

20. The image editing device according to claim 11,
wherein generating the edited source image comprises applying the transformation equation to the edited target image,
and extracting only a region corresponding to the edited region from the transformed result,
and reflecting the extracted region in the original source image.
